(19) United States
(12) Patent Application Publication
(10) Pub. No.: US 2023/0038505 A1
(43) Pub. Date: Feb. 9, 2023

(54) FLOW CELL ASSEMBLIES AND RELATED REAGENT SELECTOR VALVES

(71) Applicant: ILLUMINA, INC., San Diego, CA (US)

(72) Inventors: Bradley Drews, San Diego, CA (US); Reto Schoch, Danville, CA (US); Tarun Khurana, Fremont, CA (US); Rajagopal Panchapakesan, Escondido, CA (US)

(21) Appl. No.: 17/790,077

(22) PCT Filed: Dec. 21, 2020
(86) PCT No.: PCT/US20/66346

§ 371 Date: Jun. 29, 2022

Related U.S. Application Data
(60) Provisional application No. 62/955,176, filed on Dec. 30, 2019.

(51) Int. Cl. B01L 3/00

(52) U.S. Cl. CPC B01L 3/502738; B01L 2200/04; B01L 2200/16; B01L 2300/0877; B01L 2400/0644; B01L 2400/0622; B01L 2300/0654

(57) ABSTRACT

Flow cell assemblies and related reagent selector valves. In accordance with an implementation, an apparatus includes a system including a reagent cartridge receptacle. The apparatus includes a flow cell assembly. The apparatus includes a reagent cartridge receivable within the reagent cartridge receptacle. The reagent cartridge including a plurality of reagent reservoirs. The apparatus includes a manifold assembly. The manifold assembly including a reagent selector valve adapted to be fluidically coupled to the reagent reservoirs and to selectively flow reagent from a corresponding reagent reservoir to the flow cell assembly. At least a surface of the manifold assembly associated with the reagent selector valve is coupled to a portion of the flow cell assembly.

### CROSS-REFERENCE TO RELATED APPLICATIONS

This application claims priority to U.S. Provisional Application No. 62/955,176, filed Dec. 30, 2019, the content of which is incorporated by reference herein in its entirety and for all purposes.

### BACKGROUND

Sequencing platforms may include valves and pumps. The valves and pumps may be used to perform various fluidic operations.

### SUMMARY

In accordance with a first implementation, an apparatus comprises or includes a system comprising or including a reagent cartridge receptacle. The apparatus comprises or includes a flow cell assembly. The apparatus comprises or includes a reagent cartridge receivable within the reagent cartridge receptacle. The reagent cartridge comprising or including a plurality of reagent reservoirs. The apparatus comprises or includes a manifold assembly. The manifold assembly comprising or including a reagent selector valve adapted to be fluidically coupled to the reagent reservoirs and to selectively flow reagent from a corresponding reagent reservoir to the flow cell assembly. At least a surface of the manifold assembly associated with the reagent selector valve is coupled to a portion of the flow cell assembly.

In accordance with a second implementation, an apparatus comprises or includes a flow cell assembly. The apparatus comprises or includes a system comprising or including a manifold assembly and a flow cell receptacle adapted to carry the flow cell assembly. The manifold assembly comprising or including a reagent selector valve disposed immediately adjacent to the flow cell assembly. The reagent selector valve comprising or including a surface configured to directly couple to a portion of the flow cell assembly and adapted to selectively flow reagent to the flow cell assembly. The reagent selector valve comprises at least one of a ceramic rotor or a ceramic stator. The reagent selector valve comprising or including a valve drive assembly operably coupled to the reagent selector valve. The valve drive assembly comprising or including a brushless motor.

In accordance with a third implementation, an apparatus comprising or includes a system comprising or including a reagent cartridge receptacle. The apparatus comprises or includes a flow cell assembly. The apparatus comprises or includes a reagent cartridge receivable within the reagent cartridge receptacle. The reagent cartridge comprising or including a plurality of reagent reservoirs. The apparatus comprising or including a manifold assembly coupled immediately adjacent to the flow cell assembly. The manifold assembly comprising or including a reagent selector valve adapted to be fluidically coupled to the reagent reservoirs and to selectively flow reagent from a corresponding reagent reservoir to the flow cell assembly.

In accordance with a fourth implementation, an apparatus comprises or includes a flow cell assembly. The apparatus comprises or includes a system comprising or including a manifold assembly and a flow cell receptacle adapted to carry the flow cell assembly. The manifold assembly disposed immediately adjacent to the flow cell assembly and comprising or including a reagent selector valve adapted to selectively flow reagent to the flow cell assembly.

In accordance with a fifth implementation, an apparatus comprises or includes a system comprising or including a manifold assembly and a flow cell receptacle. The manifold assembly disposed immediately adjacent to the flow cell assembly and comprising or including a reagent selector valve adapted to selectively flow reagent.

In further accordance with the foregoing first, second, third, fourth, and/or fifth implementations, an apparatus and/or method may further comprise or include any one or more of the following:

In accordance with an implementation, the surface of the reagent selector valve is directly mechanically coupled to the flow cell assembly.

In accordance with another implementation, the reagent selector valve comprises or includes at least one of a ceramic rotor or a ceramic stator.

In accordance with another implementation, the manifold assembly further comprises or includes a valve drive assembly operably coupled to the reagent selector valve.

In accordance with another implementation, the valve drive assembly comprises or includes a brushless motor.

In accordance with another implementation, the manifold assembly is adapted to be directly coupled to the flow cell assembly.

In accordance with another implementation, the system comprises or includes the manifold assembly.

In accordance with another implementation, the system comprises or includes a flow cell receptacle adapted to carry the flow cell assembly.

In accordance with another implementation, the reagent selector valve of the manifold assembly is disposed within the flow cell receptacle.

In accordance with another implementation, the surface of the reagent selector valve is adapted to be directly mechanically coupled to the flow cell assembly.

In accordance with another implementation, the manifold assembly is disposed within the flow cell receptacle.

In accordance with another implementation, the reagent selector valve comprises or includes a bypass port.

In accordance with another implementation, further comprising or including a bypass fluidic line and a cache. The bypass fluidic line fluidically coupling the bypass port and the cache.

In accordance with another implementation, the manifold assembly comprises or includes a flow cell valve coupled between the reagent selector valve and the flow cell assembly. The flow cell assembly comprises or includes a flow cell having a plurality of channels. The flow cell valve is adapted to selectively flow reagent to the corresponding channels.

In accordance with another implementation, the flow cell valve comprises or includes a plurality of outlet ports adapted to be coupled to corresponding channels of the flow cell.

In accordance with another implementation, the flow cell valve and the reagent selector valve have opposing surfaces. Further comprising or including a valve drive assembly adapted to interface with the flow cell valve and the reagent selector valve at the opposing surfaces to control a position of the corresponding valves.

In accordance with another implementation, the flow cell valve comprises or includes a flow cell valve body having a flow cell valve stator and a flow cell valve rotor. The flow cell valve body having a common fluidic line and a plurality of flow cell valve fluidic lines. The common fluidic line coupled to the reagent selector valve. The flow cell valve rotor interfaces with the flow cell valve stator to fluidically couple the common fluidic line and one or more of the flow cell valve fluidic lines.

In accordance with another implementation, the flow cell valve rotor comprises or includes a radial groove adapted to fluidically couple the common fluidic line and the one or more of the flow cell valve fluidic lines.

In accordance with another implementation, the flow cell valve rotor comprises or includes an arc-shaped groove coupled to a distal end of the radial groove and adapted to allow the common fluidic line to be fluidically coupled to more than one of the flow cell valve fluidic lines.

In accordance with another implementation, the reagent selector valve comprises or includes a reagent valve body having a reagent valve stator and a reagent valve rotor. The reagent valve body having a common fluidic line and a plurality of reagent fluidic lines. The reagent fluidic lines adapted to be fluidically coupled to the corresponding reagent reservoirs. The reagent valve rotor interfaces with the reagent valve stator to fluidically couple the common fluidic line and a corresponding reagent fluidic line.

In accordance with another implementation, the reagent valve rotor comprises or includes a radial groove adapted to fluidically couple the common fluidic line and the corresponding reagent fluidic line.

In accordance with another implementation, the reagent valve body comprises or includes a flow cell interface and the flow cell assembly is coupled to the flow cell interface.

In accordance with another implementation, further comprising or including a valve drive assembly adapted to interface with and be coupled adjacent to an end of the reagent selector valve.

In accordance with another implementation, the flow cell assembly comprises or includes a body coupled to the reagent selector valve.

In accordance with another implementation, further comprising or including a vibration isolation assembly.

In accordance with another implementation, the vibration isolation assembly comprises or includes a housing rotationally coupled to the reagent selector valve and the valve drive assembly.

In accordance with another implementation, the manifold assembly is disposed within the flow cell receptacle.

In accordance with another implementation, the manifold assembly is adapted to be directly coupled to the flow cell assembly.

In accordance with another implementation, the manifold assembly comprises or includes a flow cell valve coupled between the reagent selector valve and the flow cell assembly. The flow cell assembly comprises or includes a flow cell having a plurality of channels. The flow cell valve is adapted to selectively flow reagent to the corresponding channels.

In accordance with another implementation, further comprising or including a vibration isolation assembly.

In accordance with another implementation, the vibration isolation assembly comprises or includes a magnet and is adapted to magnetically levitate the manifold assembly.

In accordance with another implementation, the vibration assembly comprises or includes a shock absorber.

It should be appreciated that all combinations of the foregoing concepts and additional concepts discussed in greater detail below (provided such concepts are not mutually inconsistent) are contemplated as being part of the subject matter disclosed herein and/or may be combined to achieve the particular benefits of a particular aspect. In particular, all combinations of claimed subject matter appearing at the end of this disclosure are contemplated as being part of the subject matter disclosed herein.

### BRIEF DESCRIPTION OF THE DRAWINGS

FIG. 1A illustrates a schematic diagram of an implementation of a system in accordance with the teachings of this disclosure.

FIG. 1B illustrates a schematic diagram of another implementation of the system of FIG. 1A.

FIG. 1C illustrates a schematic diagram of another implementation of the system of FIG. 1A.

FIG. 2 is a schematic implementation of the flow cell valve and the reagent selector valve of FIG. 1A.

FIG. 3 is a schematic implementation of the reagent selector valve of FIG. 1A.

FIG. 4A is a schematic implementation of the reagent selector valve, the valve drive assembly, and the flow cell assembly of FIG. 1A.

FIG. 4B is a cross-sectional view of the reagent selector valve, the valve drive assembly, and the flow cell assembly of FIG. 4A.

FIG. 5 is another schematic implementation of the flow cell assembly of FIG. 1A showing different configurations/positions of the reagent selector valve.

FIG. 6 is another schematic illustration of valve drive assembly, the reagent selector valve, and the flow cell assembly.

FIG. 7 illustrates an isometric view of an implementation of a vibration isolation assembly including a housing and a shock absorber.

### DETAILED DESCRIPTION

Although the following text discloses a detailed description of implementations of methods, apparatuses and/or articles of manufacture, it should be understood that the legal scope of the property right is defined by the words of the claims set forth at the end of this patent. Accordingly, the following detailed description is to be construed as examples only and does not describe every possible implementation, as describing every possible implementation would be impractical, if not impossible. Numerous alternative implementations could be implemented, using either current technology or technology developed after the filing date of this patent. It is envisioned that such alternative implementations would still fall within the scope of the claims.

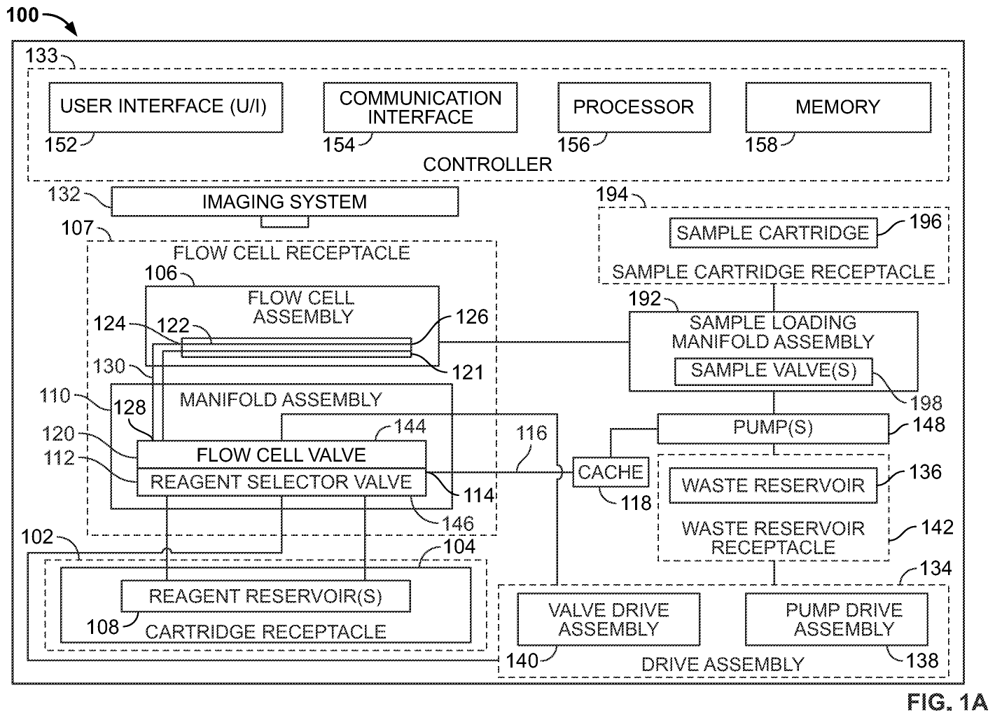

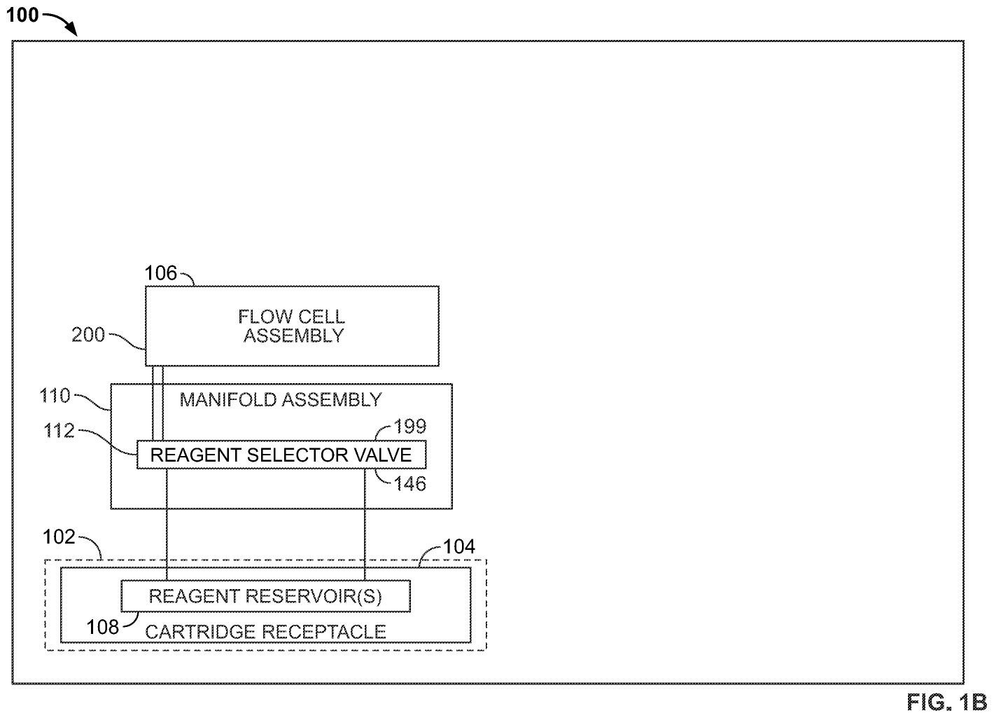

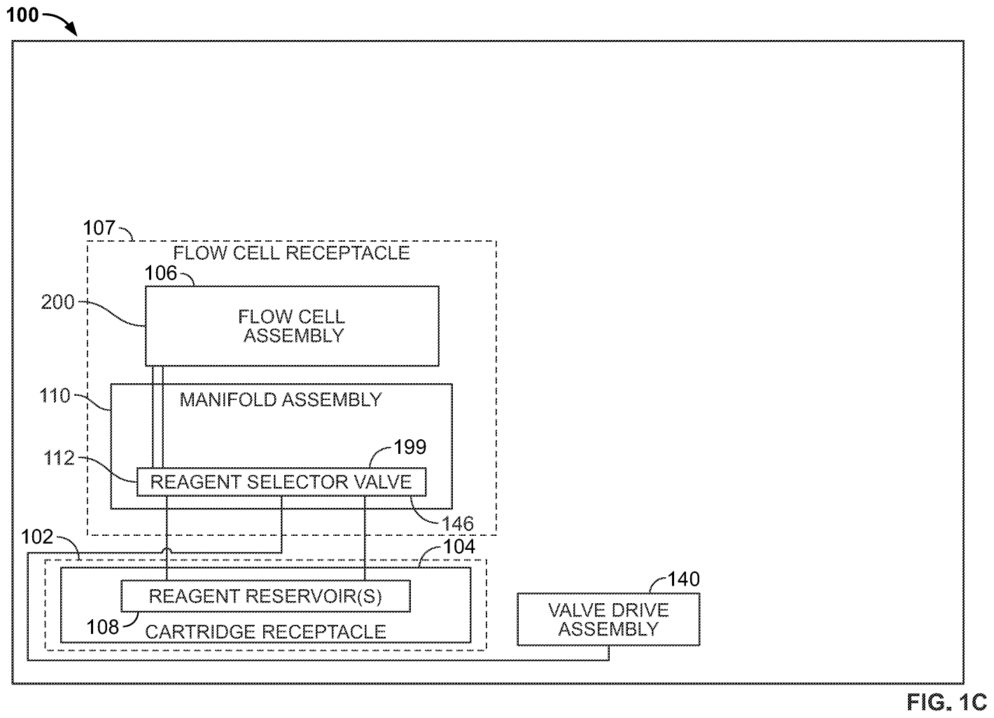

FIG. 1A illustrates a schematic diagram of an implementation of a system 100 in accordance with the teachings of this disclosure. The system 100 can be used to perform an analysis on one or more samples of interest. The sample may include one or more DNA clusters that have been linearized to form a single stranded DNA (sstDNA). In the implementation shown, the system 100 includes a reagent cartridge receptacle 102 that is adapted to receive a reagent cartridge 104. The system 100 carries a flow cell assembly 106. The system 100 includes a flow cell receptacle 107.

The system also includes an imaging system 132, a controller 133, a drive assembly 134, and a waste reservoir 136. The drive assembly 134 includes a pump drive assembly 138 and a valve drive assembly 140. The valve drive assembly 140 may include a brushless direct current (DC) motor, a stepper motor, and/or a strain wave gear servo drive. However, other ways of implementing the valve drive assembly 140 may prove suitable. For example, a piezoelectric motor may be used.

The valve drive assembly 140 may be adapted to perform a threshold number of relatively high torque events (HTEs). A relatively high torque event may be associated with approximately 160 ounces per inch. However, other torque values may be associated with a high torque event. The threshold number of high torque events may be approximately 1000. However, a different number of high torque events may be achieved based on design characteristics, materials used, and/or other operating parameters.

The controller 133 is electrically and/or communicatively coupled to the drive assembly 134 and the imaging system 132 and is adapted to cause the drive assembly 134 and/or the imaging system 132 to perform various functions as disclosed herein. The waste reservoir 136 may be selectively receivable within a waste reservoir receptacle 142 of the system 100.

The reagent cartridge 104 may carry one or more samples of interest. The drive assembly 115 interfaces with the reagent cartridge 104 to flow one or more reagents (e.g., A, T, G, C nucleotides) that interact with the sample through the reagent cartridge 104 and/or through the flow cell assembly 106.

In an implantation shown, a reversible terminator is attached to the reagent to allow a single nucleotide to be incorporated by the sstDNA per cycle. In some such implementations, one or more of the nucleotides has a unique fluorescent label that emits a color when excited. The color (or absence thereof) is used to detect the corresponding nucleotide. In the implementation shown, the imaging system 132 is adapted to excite one or more of the identifiable labels (e.g., a fluorescent label) and thereafter obtain image data for the identifiable labels. The labels may be excited by incident light and/or a laser and the image data may include one or more colors emitted by the respective labels in response to the excitation. The image data (e.g., detection data) may be analyzed by the system 100. The imaging system 132 may be a fluorescence spectrophotometer including an objective lens and/or a solid-state imaging device. The solid-state imaging device may include a charge coupled device (CCD) and/or a complementary metal oxide semiconductor (CMOS).

After the image data is obtained, the drive assembly 134 interfaces with the reagent cartridge 104 to flow another reaction component (e.g., a reagent) through the reagent cartridge 104 that is thereafter received by the waste reservoir 142 and/or otherwise exhausted by the reagent cartridge 104. The reaction component performs a flushing operation that chemically cleaves the fluorescent label and the reversible terminator from the sstDNA. A flushing operation may also be performed using air. The sstDNA is then ready for another cycle.

The reagent cartridge 104 includes a plurality of reagent reservoirs 108. The system 100 includes a manifold assembly 110. The manifold assembly 110 may be positioned within and/or adjacent to the flow cell assembly 107. Alternatively, the manifold assembly 110 may be part of the flow cell assembly 106 and/or the reagent cartridge 104.

In the implementation shown, at least a portion of the manifold assembly 110 is coupled immediately adjacent to the flow cell assembly 106. The portion of the manifold assembly 110, such as a minivalve assembly, may be directly coupled to the flow cell assembly 106 or may be spaced from the flow cell assembly 106 via, for example, an intermediary component. Advantageously, positioning a portion of the manifold assembly 110 immediately adjacent to the flow cell assembly 106 may reduce reagent consumption, reduce dead volume within, for example, fluidic lines, reduce carry over, reduce switching times, and/or time-to-time results.

The manifold assembly 110 includes a reagent selector valve 112. The regent selector valve 112 is adapted to be fluidically coupled to the reagent reservoirs 108. The reagent selector valve 112 is also adapted to selectively flow reagent from a corresponding reagent reservoir 108 to the flow cell assembly 106. In some implementations, the reagent selector valve 112 may have a small foot print. For example, the reagent selector valve 112 may have a footprint of approximately 45 millimeters (mm) by 45 mm. Other dimensions for the reagent selector valve 112 may prove suitable. For example, the footprint of the reagent selector valve 112 may be less than 45 mm by 45 mm.

The reagent selector valve 112 may include a bypass port 114. The system includes a bypass fluidic line 116 and a cache 118. The bypass fluidic line 116 fluidically couples the bypass port 114 and the cache 118. The cache 118 may be adapted to temporarily store one or more reaction components during, for example, bypass manipulations of the system 100 of FIG. 1A. While the cache 118 is shown as part of the system 100, in another implementation, the cache 118 may be located in a different location. For example, the cache 118 may be located in the manifold assembly 110 and/or the reagent cartridge 104. Other locations for the cache 118 may prove suitable.

The manifold assembly 110 also includes a flow cell valve 120. The flow cell valve 120 can be coupled between the reagent selector valve 112 and the flow cell assembly 106. The flow cell valve 120 may be directly coupled the reagent selector valve 112. In some implementations, such as if only a single flow cell or a single channel is utilized, the flow cell valve 120 may be omitted such that the reagent selector valve 112 is directly fluidically coupled to the flow cell and/or channel.

The flow cell assembly 106 includes a flow cell 121 including at least one channel 122, a flow cell inlet 124, and a flow cell outlet 126. In an implementation when the flow cell includes a plurality of channels 122, as shown, the flow cell valve 120 is adapted to selectively flow reagent to the corresponding channels 122.

The flow cell valve 120 includes a plurality of outlet ports 128. The outlet ports 128 are adapted to be coupled to corresponding channels 122 of the flow cell 106. Fluidic lines 130 are shown fluidically coupling the outlet ports 128 and the channels 122. The fluidic lines 130 may be part of a fluidic coupling. The fluidic coupling may be flexible. The fluidic coupling may be a laminate.

The flow cell valve 120 and the reagent selector valve 112 can have opposing surfaces 144, 146. In some implementations, the valve drive assembly 140 is adapted to interface with the flow cell valve 120 and the reagent selector valve 112 at the opposing surfaces 144, 146 to control a position of the corresponding valves 120, 112. However, the valve drive assembly 140 may interface with the valves 120, 112 in different ways.

Referring now to the drive assembly 134, in the implementation shown, the drive assembly 134 includes the pump drive assembly 138 and the valve drive assembly 140. The pump drive assembly 138 is adapted to interface with one or more pumps 148 to pump fluid through the reagent cartridge 104. The pump 148 may be implemented by a syringe pump, a peristaltic pump, a diaphragm pump, etc. While the pump 148 may be positioned between the flow cell assembly 106 and the waste reservoir 142, in other implementations, the pump 148 may be positioned upstream of the flow cell assembly 106 or omitted entirely.

In the implementation shown, the system 100 includes a sample loading manifold assembly 192 and a sample cartridge receptacle 194 adapted to receive a sample cartridge 196. The sample loading manifold assembly 192 includes one or more sample valves 198. The sample valves 198 may be referred to as sample loading valves.

The sample loading manifold assembly 192 and the pump 148 are adapted to flow one or more samples of interest from the sample cartridge 195 toward the flow cell assembly 106. In an implementation, the sample loading manifold assembly 192 may be adapted to individually load/address each channel 122 of the flow cell 121 with a sample of interest. The process of loading the channels 122 with a sample of interest may occur automatically using the system 100 of FIG. 1A.

Referring to the controller 133, in the implementation shown, the controller 133 includes a user interface 152, a communication interface 154, one or more processors 156, and a memory 158 storing instructions executable by the one or more processors 156 to perform various functions including the disclosed implementation. The user interface 152, the communication interface 154, and the memory 158 are electrically and/or communicatively coupled to the one or more processors 156.

In an implementation, the user interface 152 is adapted to receive input from a user and to provide information to the user associated with the operation of the system 100 and/or an analysis taking place. The user interface 152 may include a touch screen, a display, a key board, a speaker(s), a mouse, a track ball, and/or a voice recognition system. The touch screen and/or the display may display a graphical user interface (GUI).

In an implementation, the communication interface 154 is adapted to enable communication between the system 100 and a remote system(s) (e.g., computers) via a network(s). The network(s) may include the Internet, an intranet, a local-area network (LAN), a wide-area network (WAN), a coaxial-cable network, a wireless network, a wired network, a satellite network, a digital subscriber line (DSL) network, a cellular network, a Bluetooth connection, a near field communication (NFC) connection, etc. Some of the communications provided to the remote system may be associated with analysis results, imaging data, etc. generated or otherwise obtained by the system 100. Some of the communications provided to the system 100 may be associated with a fluidics analysis operation, patient records, and/or a protocol(s) to be executed by the system 100.

The one or more processors 156 and/or the system 100 may include one or more of a processor-based system(s) or a microprocessor-based system(s). In some implementations, the one or more processors 156 and/or the system 100 includes one or more of a programmable processor, a programmable controller, a microprocessor, a microcontroller, a graphics processing unit (GPU), a digital signal processor (DSP), a reduced-instruction set computer (RISC), an application specific integrated circuit (ASIC), a field programmable gate array (FPGA), a field programmable logic device (FPLD), a logic circuit, and/or another logic-based device executing various functions including the ones described herein.

The memory 158 can include one or more of a semiconductor memory, a magnetically readable memory, an optical memory, a hard disk drive (HDD), an optical storage drive, a solid-state storage device, a solid-state drive (SSD), a flash memory, a read-only memory (ROM), erasable programmable read-only memory (EPROM), electrically erasable programmable read-only memory (EEPROM), a random-access memory (RAM), a non-volatile RAM (NVRAM) memory, a compact disc (CD), a compact disc read-only memory (CD-ROM), a digital versatile disk (DVD), a Blu-ray disk, a redundant array of independent disks (RAID) system, a cache, and/or any other storage device or storage disk in which information is stored for any duration (e.g., permanently, temporarily, for extended periods of time, for buffering, for caching).

FIG. 1B illustrates a schematic diagram of another implementation of the system 100 of FIG. 1A. In the implementation shown, the system 100 includes the reagent cartridge receptacle 102. The flow cell assembly 106 is included. The reagent cartridge 104 is receivable within the reagent cartridge receptacle 102. The reagent cartridge 108 includes the plurality of reagent reservoirs 108.

The manifold assembly 110 is included. The manifold assembly 110 includes the reagent selector valve 112 and is adapted to be fluidically coupled to the reagent reservoirs 108 and to selectively flow reagent from a corresponding reagent reservoir 108 to the flow cell assembly 106. At least a surface 199 of the manifold assembly 110 associated with the reagent selector valve 112 is coupled to a portion 200 of the flow cell assembly 106.

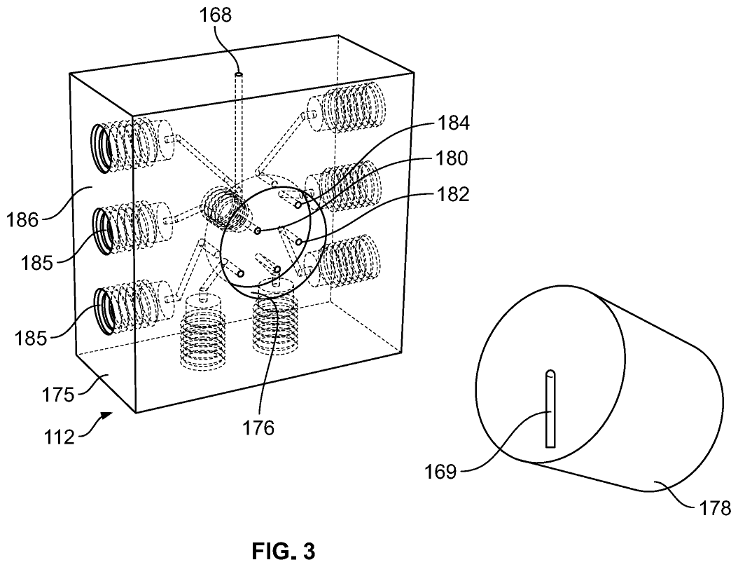

FIG. 1C illustrates a schematic diagram of another implementation of the system 100 of FIG. 1A. In the implementation shown, the flow cell assembly is included. The system 100 includes the manifold assembly 110 and the flow cell receptacle 107 adapted to carry the flow cell assembly 106. The manifold assembly includes the reagent selector valve 112 disposed immediately adjacent to the flow cell assembly 106. The reagent selector valve 112 includes the surface 119 configured to directly couple to the portion 200 of the flow cell assembly 106 and is adapted to selectively flow reagent to the flow cell assembly 106. The reagent selector valve 112 includes at least one of a ceramic rotor or a ceramic stator (see, for example, FIG. 3). The valve drive assembly 140 is included. The valve drive assembly 140 is operatively coupled to the reagent selector valve 112. The valve drive assembly 140 includes a brushless motor.

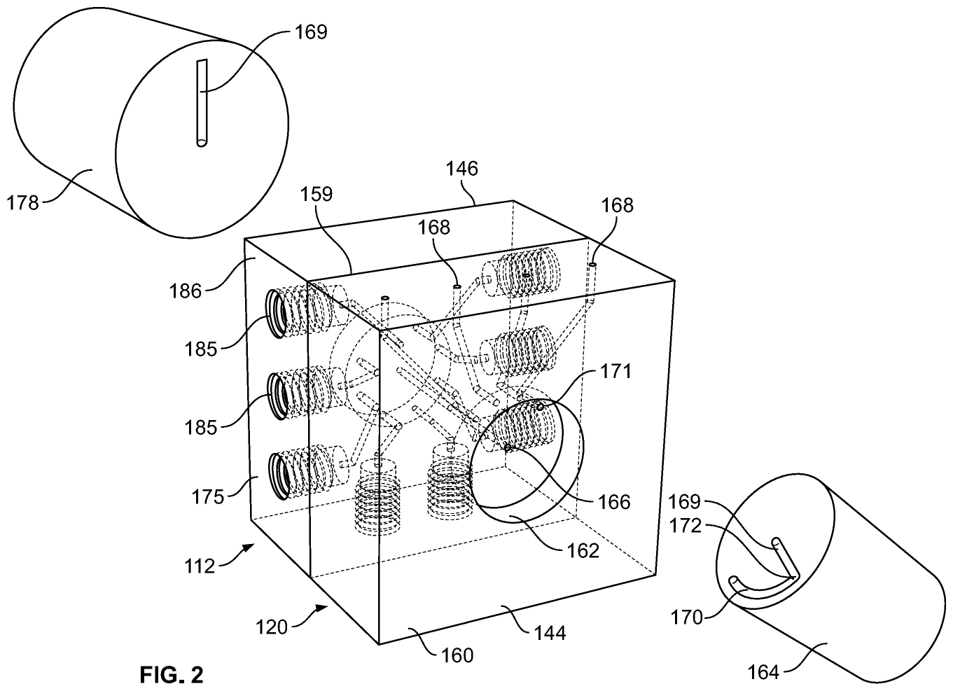

FIG. 2 is a schematic implementation of the flow cell valve 120 and the reagent selector valve 112 of FIG. 1A. The combination of the flow cell valve 120 and the reagent selector valve 112 may be referred to as a dual rotary valve. The flow cell valve 120 and/or the reagent selector valve 112 may be adapted to perform a threshold number of life cycles. The life cycles may be associated with fluidically coupling the flow cell valve 120 and/or the reagent selector valve 112 with the flow cell assembly 106 and/or the reagent cartridge 104. The threshold number of life cycles may include approximately greater than 2000 mounting events. The number of life cycles may include approximately 4 million moves port-to-port. Other threshold values for the different life cycles may be achieved based on design requirements and/or materials used, for example.

The flow cell valve 120 and the reagent selector valve 112 may be controlled (e.g., actuated) electronically and/or manually. As a result of controlling the flow cell valve 120 and the reagent selector valve 112 in this way, user error may be reduced and the system 100 may be relatively (or more) user friendly.

The flow cell valve 120 and the reagent selector valve 112 are coupled at an interface 159. In the implementation shown, the flow cell valve 120 has a flow cell valve body 160 having a flow cell valve stator 162. The flow cell stator 162 may include ceramic and/or a polymer hybrid. Other materials for the flow cell valve 120 may prove suitable. The flow cell stator 162 may be sized to fit within a small area, such as 25 millimeters (mm) by 25 mm. However, other sizes for the flow cell stator 162 may prove suitable.

The flow cell valve 120 also includes a flow cell valve rotor 164. The flow cell valve rotor 164 may include ceramic and/or a polymer hybrid. The flow cell valve body 160 has a common fluidic line 166 and a plurality of flow cell fluidic lines 168. The flow cell fluidic lines 168 are adapted to be coupled to the flow cell assembly 106. In some implementations, the common fluidic line 166 is approximately 65 millimeters and, in other implementations, the common fluidic line 166 is approximately 259 mm. Thus, the common fluidic line 166 may be between about 65 mm and about 259 mm. However, the common fluidic line 166 may be any other length. The flow cell fluidic lines 168 may be used to individually address the channels 122. The common fluidic line 166 is coupled to the reagent selector valve 112.

The flow cell valve rotor 162 is adapted to interface with the flow cell valve stator 162 to fluidically couple the common fluidic line 166 and one or more of the flow cell valve fluidic lines 168. For example, the flow cell valve stator 162 may be rotated by the valve drive assembly 140 to cause the common fluidic line 166 to be fluidically coupled to one of the flow cell valve fluidic lines 168. While four flow cell valve fluidic lines 168 are shown, any number of flow valve fluidic lines may be included instead.

The flow cell valve rotor 164 includes a radial groove 169 that is adapted to fluidically couple (e.g., address) the common fluidic line 166 and one or more of the flow cell valve fluidic lines 168. In an implementation, the flow cell valve rotor 164 may be rotated between approximately 0° and approximately 90°. However, the flow cell valve rotor 164 may be rotated more or less depending on the position of corresponding ports 171 of the flow cell valve fluidic lines 168 that open into the flow cell stator 162.

The radial groove 169 may include chamfered sides. The chamfered sides may be adapted to reduce carry over. The flow cell valve rotor 164 also includes an arc-shaped groove 170. The arc-shaped groove 170 is coupled to a distal end 172 of the radial groove 169 and is adapted to allow the common fluidic line 166 to be fluidically coupled to more than one of the flow cell valve fluidic lines 168. For example, the flow cell valve rotor 164 may be indexed in a manner such that the arc-shaped groove 170 covers two or more ports 171 of the flow cell valve fluidic lines 168, thereby allowing fluidic communication with more than two of the flow cell valve fluidic lines 168.

FIG. 3 is a schematic implementation of the reagent selector valve 112 of FIG. 1A. The reagent selector valve 112 includes a reagent selector valve body 175 having a reagent valve stator 176. The reagent selector valve 112 also includes a reagent valve rotor 178. The reagent valve stator 176 and/or the reagent valve rotor 178 may include ceramic and/or a polymer hybrid. Other materials for the reagent selector valve 112 may prove suitable. The reagent selector valve body 175 includes a common fluidic line 180, a plurality of reagent fluidic lines 182, and the flow cell fluidic line 108. The reagent fluidic lines 182 are adapted to be fluidically coupled to the corresponding reagent reservoirs 108. The common fluidic line 180 is fluidically coupled to the reagent fluidic lines 182 and the flow cell fluidic line 168.

The reagent valve rotor 178 is adapted to interface with the reagent valve stator 176 to fluidically couple the common fluidic line 180 and a corresponding reagent fluidic line 182. Specifically, in the implementation shown, the reagent valve rotor 178 includes a radial groove 169 adapted to fluidically couple the common fluidic line 180 and the corresponding reagent fluidic line 182. The common fluidic line 180 may be fluidically coupled to the flow cell fluidic line 168 and/or the bypass port 114.

The reagent fluidic lines 182 have outlet ports 184 at the reagent valve stator 176. The reagent fluidic lines 182 also include a plurality of inlet ports 185. The inlet ports 185 are defined by sides 186 of the reagent selector valve body 175. While the inlet ports 185 are defined by three of the sides 186, the inlet ports 185 may be defined differently. For example, the inlet ports 185 may be defined by two of the sides 186. While the reagent valve rotor 178 is not shown including an arc-shaped groove such as the arc-shaped groove 170 of the flow cell valve rotor 164, the reagent valve rotor 178 may alternatively include an arc-shaped groove.

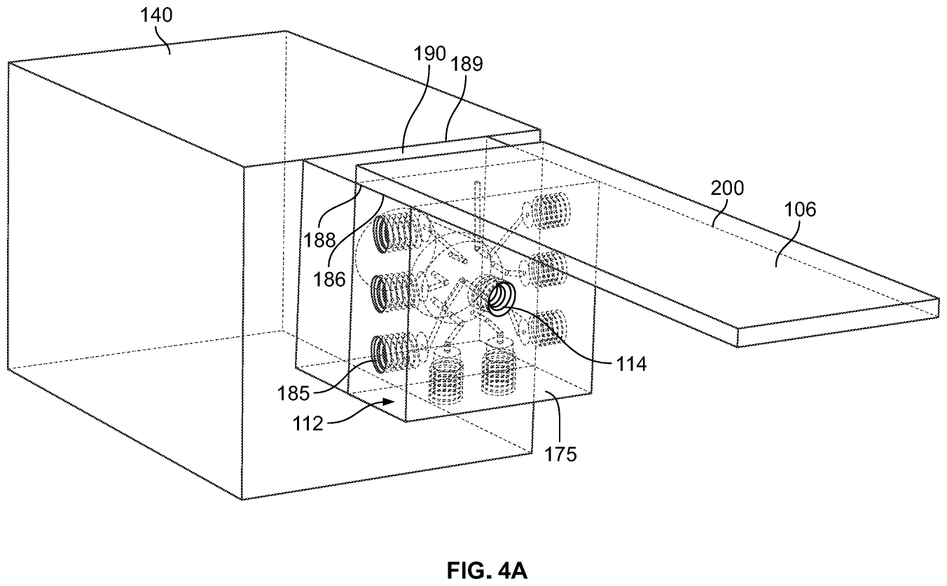

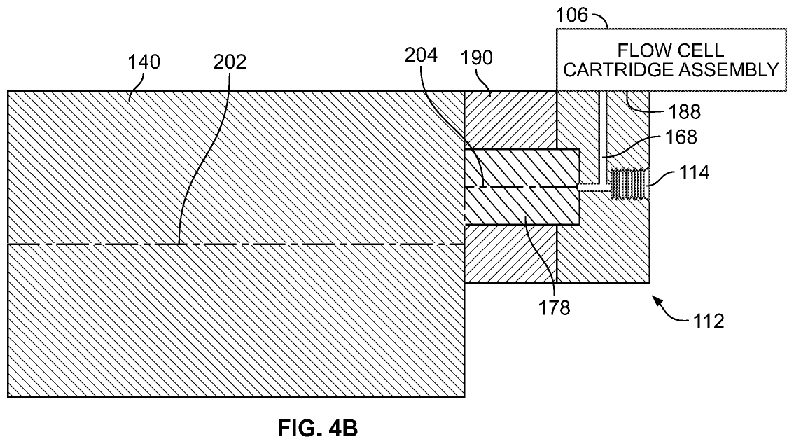

FIG. 4A is a schematic implementation of the reagent selector valve 112, the valve drive assembly 140, and the flow cell assembly 106 of FIG. 1A. In the implementation shown, the reagent selector valve body 175 has a flow cell interface 188. The flow cell interface 188 may be a side 186 of the reagent selector valve body 175 where the inlet ports 185 are not defined but where the flow cell fluidic line 168 may be defined allowing for fluidic communication with the flow cell assembly 106. The flow cell assembly 106 is coupled to the flow cell interface 188. Thus, a body 201 of the flow cell assembly 106 is coupled to the reagent selector valve 112. Put another way, a surface of the reagent selector valve 112 is directly mechanically coupled to the flow cell assembly 106. As an alternative, the body 201 of the flow cell assembly 106 may be coupled to the flow cell valve 120. In some implementations, an intermediary component, such as a flexible manifold or other fluidic transporting component may be implemented between the flow cell interface 188 of the reagent selector valve body 175 and the flow cell assembly 106 and/or between the flow cell valve 120 and the flow cell assembly 106. Other arrangements may prove suitable.

The valve drive assembly 140 is adapted to interface with and is coupled adjacent to an end 189 of the reagent selector valve 112. For example, the valve drive assembly 140 may be adapted to rotate the reagent valve rotor 178.

While the flow cell valve 120 is not shown in FIG. 4A, in other implementations, the flow cell valve 120 may be included. For example, the flow cell valve 120 may be included when the flow cell 121 includes a plurality of channels 122 and/or when the flow cell assembly 106 does not include a manifold that couples a plurality of the channels 122 and the reagent selector valve 112.

In the implementation shown, a gear box 190 is also included. The gear box 190 and/or the valve drive assembly 140 may be adapted to apply a relatively high torque value to the reagent selector valve 112 and/or the flow cell valve 120. The relative high torque value may be approximately 140 ounces per inch. Other torque values may be achieved using the gear box 190 and/or the valve drive assembly 140. The gear box 190 may guide rotation of the reagent valve rotor 178. The gear box 190 may be a multi-stage planetary gear box or a spur gear box. Other types of gear boxes may prove suitable. The gear box 190 is coupled between the valve drive assembly 140 and the reagent selector valve 112. The gear box 190 may be adapted to reduce a likelihood that vibrations generated by the valve drive assembly 140, the reagent reservoir valve 112, and/or the flow cell valve 120 affect the flow cell assembly 106. The gear box 190 may include a strain wave gear drive. The gear box 190 may include a harmonic gear. Other types of gears may prove suitable. The gear box 190 may be adapted to provide a gear reduction and a large torque.

FIG. 4B is a cross-sectional view of the reagent selector valve 112, the valve drive assembly 140, and the flow cell assembly 106 of FIG. 4A. The gear box 190 is also included. In the implementation shown, a longitudinal axis 202 of the valve drive assembly 140 is offset relative to a longitudinal axis 204 of the reagent selector valve 112. Thus, the longitudinal axis 202 of the valve drive assembly 140 and the longitudinal axis 204 of the reagent selector valve 112 are asymmetric. In other implementations, the gear box 190 and reagent selector valve 112 can be in-line with the longitudinal axis 202 of the valve drive assembly 140.

In the implementation shown, the gear box 190 may be a multi-stage planetary gear box or a spur gear box. The gear box 190 may be adapted to allow the axes 202, 204 to be offset relative to one another. The offset axes 202, 204 may allow the flow cell cartridge assembly 106 to be coupled to the flow cell interface 188 without the valve drive assembly 140 obstructing the coupling. Specifically, when a larger valve drive assembly 140 is used, offsetting the axes 202, 204 may allow for the flow cell cartridge assembly 106 to be coupled to the flow cell interface 188. The flow cell interface 188 may be considered a topmost level of the reagent selector valve 112 based on the orientation shown in FIG. 4. However, the flow cell interface 188 may be positioned elsewhere on the reagent selector valve 112 or on any of the other components disclosed.

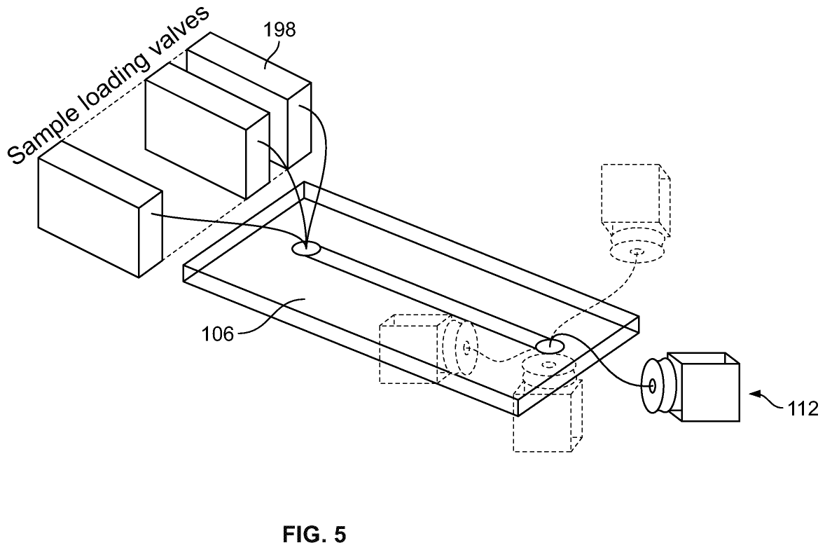

FIG. 5 is another schematic implementation of the flow cell assembly 106 of FIG. 1A showing different configurations/positions of the reagent selector valve 112. For example, the reagent selector valve 112 can be positioned above the flow cell assembly 106, below the flow cell assembly 106, directly coupled to the flow cell assembly 106, or in line with the flow cell assembly 106. Alternative positions of the reagent selector valve 112 are shown in dashed lines. Other relative positions between the flow cell assembly 106 and the reagent selector valve 112 may prove suitable.

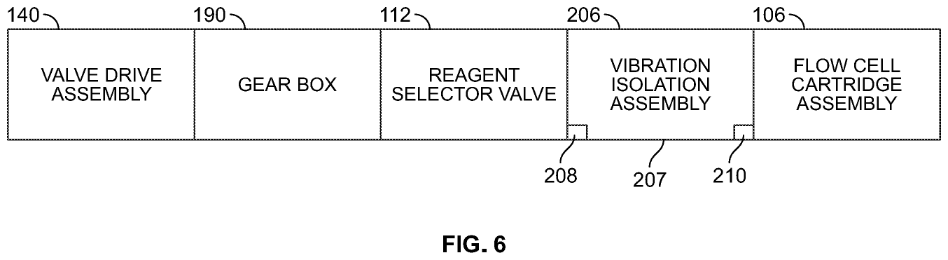

FIG. 6 is another schematic illustration of valve drive assembly 140, the reagent selector valve 112, and the flow cell assembly 106. In the implementation shown, a vibration isolation assembly 206 and the gear box 190 are also included. The vibration isolation assembly 206 may be adapted to isolate vibration displacement from the flow cell assembly 106 that may be generated when, for example, the reagent selector valve 112 is actuated.

The vibration isolation assembly 206 may include a housing 207 to which the valve drive assembly 140, the gear box 190, and the reagent selector valve 112 are rotationally coupled. The vibration isolation assembly 206 may include one or more magnets 208 that magnetically isolate and/or magnetically levitate the valve drive assembly 140, the gear box 190, and the reagent selector valve 112 in a manner that deters vibration generated by the valve drive assembly 140 and/or the reagent selector valve 112 from affecting the flow cell cartridge assembly 106. The vibration isolation assembly 206 may be implemented in different ways. For example, the vibration isolation assembly 206 may a shock absorber 210. The shock absorber 210 may include a spring, a gel isolator, a gasket, etc.

The valve drive assembly 140 may include a stepper motor. Alternatively, the valve drive assembly 140 may include a brushless DC motor. Brushless DC motors may produce less vibration when operated. Brushless DC motors may also satisfy a threshold torque value.

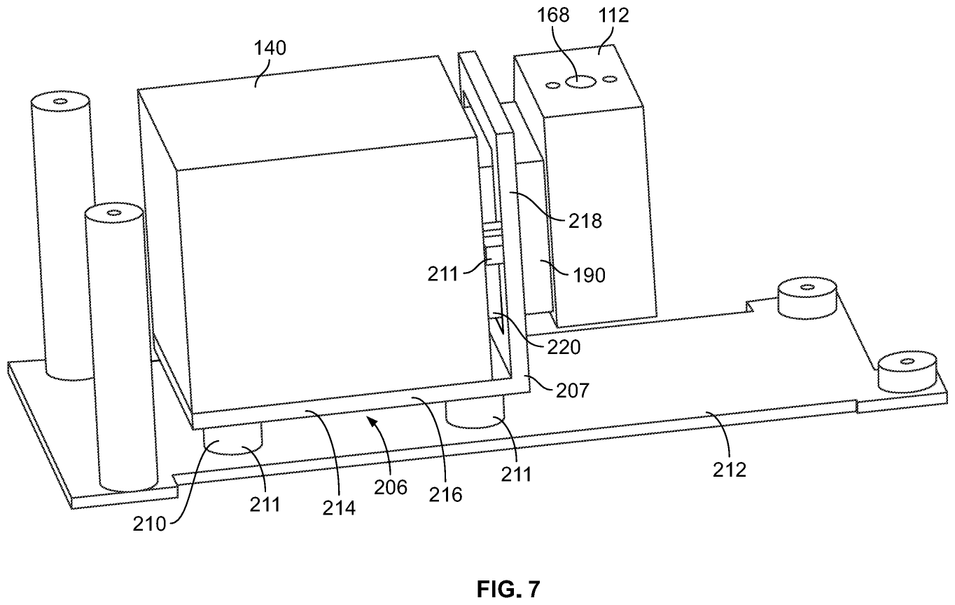

FIG. 7 illustrates an isometric view of an implementation of the vibration isolation assembly 206 including the housing 207 and the shock absorber 210. The shock absorber 210 includes a plurality of gel isolators 211. Other types of shock absorbers may additionally or alternatively be included.

In the implementation shown, the housing 207 includes a base 212 and a support 214. The support 214 is coupled to the base 212 via the shock absorbers 210. The support 214 includes a first support portion 216 and a second support portion 218. The first support portion 216 carries the valve drive assembly 140. The second support portion 218 defines a through hole 220 and is positioned between the valve drive assembly 140 and the reagent selector valve 112. The gear box 190 extends through the through hole 220 of the second support portion 218.

The gel isolators 211 may be positioned between the base 212 and the support 214. Specifically, the gel isolators 211 may be positioned between the base 212 and the first support portion 216.

The gel isolators 211 may also be positioned between the second support portion 218 and the valve drive assembly 140. Alternatively, a rigid coupling or another type of coupling may be provided between the valve drive assembly 140 and the second support portion 218. In such an implementation, four gel isolators 211 may be provided between the first support portion 216 and the base 212 but gel isolators 211 may not be provided between the second support portion 218 and the valve drive assembly 140. Other arrangements may prove suitable. Regardless of the number and/or the arrangement of the gel isolators 211 or, more generally, the shock absorber 210, the gel isolators 211 may be adapted to reduce the likelihood that operating the valve drive assembly 140 and/or the reagent selector valve 112 affects the flow cell assembly 106.

An apparatus, comprising: a system including a reagent cartridge receptacle; a flow cell assembly; a reagent cartridge receivable within the reagent cartridge receptacle, the reagent cartridge comprising a plurality of reagent reservoirs; and a manifold assembly, the manifold assembly comprising a reagent selector valve adapted to be fluidically coupled to the reagent reservoirs and to selectively flow reagent from a corresponding reagent reservoir to the flow cell assembly, wherein at least a surface of the manifold assembly associated with the reagent selector valve is coupled to a portion of the flow cell assembly.

The apparatus of any one or more of the preceding implementations and/or any one or more of the implementations disclosed below, wherein the surface of the reagent selector valve is directly mechanically coupled to the flow cell assembly.

The apparatus of any one or more of the preceding implementations and/or any one or more of the implementations disclosed below, wherein the reagent selector valve comprises at least one of a ceramic rotor or a ceramic stator.

The apparatus of any one or more of the preceding implementations and/or any one or more of the implementations disclosed below, wherein the manifold assembly further comprises a valve drive assembly operably coupled to the reagent selector valve.

The apparatus of any one or more of the preceding implementations and/or any one or more of the implementations disclosed below, wherein the valve drive assembly comprises a brushless motor.

The apparatus of any one or more of the preceding implementations and/or any one or more of the implementations disclosed below, wherein the manifold assembly comprises a flow cell valve coupled between the reagent selector valve and the flow cell assembly, wherein the flow cell assembly comprises a flow cell having a plurality of channels, wherein the flow cell valve is adapted to selectively flow reagent to the corresponding channels.

The apparatus of any one or more of the preceding implementations and/or any one or more of the implementations disclosed below, wherein the flow cell valve comprises a plurality of outlet ports adapted to be coupled to corresponding channels of the flow cell.

The apparatus of any one or more of the preceding implementations and/or any one or more of the implementations disclosed below, wherein the flow cell valve and the reagent selector valve have opposing surfaces, further comprising a valve drive assembly adapted to interface with the flow cell valve and the reagent selector valve at the opposing surfaces to control a position of the corresponding valves.

The apparatus of any one or more of the preceding implementations and/or any one or more of the implementations disclosed below, wherein the flow cell valve comprises a flow cell valve body having a flow cell valve stator and a flow cell valve rotor, the flow cell valve body having a common fluidic line and a plurality of flow cell valve fluidic lines, the common fluidic line coupled to the reagent selector valve, and wherein the flow cell valve rotor interfaces with the flow cell valve stator to fluidically couple the common fluidic line and one or more of the flow cell valve fluidic lines.

The apparatus of any one or more of the preceding implementations and/or any one or more of the implementations disclosed below, wherein the flow cell valve rotor comprises a radial groove adapted to fluidically couple the common fluidic line and the one or more of the flow cell valve fluidic lines.

The apparatus of any one or more of the preceding implementations and/or any one or more of the implementations disclosed below, wherein the flow cell valve rotor comprises an arc-shaped groove coupled to a distal end of the radial groove and adapted to allow the common fluidic line to be fluidically coupled to more than one of the flow cell valve fluidic lines.

The apparatus of any one or more of the preceding implementations and/or any one or more of the implementations disclosed below, wherein the reagent valve body comprises a flow cell interface and the flow cell assembly is coupled to the flow cell interface.

The apparatus of any one or more of the preceding implementations and/or any one or more of the implementations disclosed below, further comprising a valve drive assembly adapted to interface with and be coupled adjacent to an end of the reagent selector valve.

The apparatus of any one or more of the preceding implementations and/or any one or more of the implementations disclosed below, further comprising a vibration isolation assembly.

The apparatus of any one or more of the preceding implementations and/or any one or more of the implementations disclosed below, wherein the vibration isolation assembly comprises a housing rotationally coupled to the reagent selector valve and the valve drive assembly.

An apparatus, comprising: a flow cell assembly; and a system including a manifold assembly and a flow cell receptacle adapted to carry the flow cell assembly, the manifold assembly comprising: a reagent selector valve disposed immediately adjacent to the flow cell assembly, the reagent selector valve comprising a surface configured to directly couple to a portion of the flow cell assembly and adapted to selectively flow reagent to the flow cell assembly, wherein the reagent selector valve comprises at least one of a ceramic rotor or a ceramic stator; and a valve drive assembly operably coupled to the reagent selector valve, the valve drive assembly comprising a brushless motor.

The apparatus of any one or more of the preceding implementations and/or any one or more of the implementations disclosed below, wherein the reagent selector valve of the manifold assembly is disposed within the flow cell receptacle.

The apparatus of any one or more of the preceding implementations and/or any one or more of the implementations disclosed below, wherein the surface of the reagent selector valve is adapted to be directly mechanically coupled to the flow cell assembly.

The apparatus of any one or more of the preceding implementations and/or any one or more of the implementations disclosed below, wherein the manifold assembly further comprises a flow cell valve coupled between the reagent selector valve and the flow cell assembly, wherein the flow cell assembly comprises a flow cell having a plurality of channels, wherein the flow cell valve is adapted to selectively flow reagent to the corresponding channels.

The apparatus of any one or more of the preceding implementations and/or any one or more of the implementations disclosed below, further comprising a vibration isolation assembly.

The apparatus of any one or more of the preceding implementations and/or any one or more of the implementations disclosed below, wherein the vibration isolation assembly comprises a magnet and is adapted to magnetically levitate the manifold assembly.

The apparatus of any one or more of the preceding implementations and/or any one or more of the implementations disclosed below, wherein the vibration assembly comprises a shock absorber.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

As used herein, an element or step recited in the singular and proceeded with the word “a” or “an” should be understood as not excluding plural of said elements or steps, unless such exclusion is explicitly stated. Furthermore, references to “one implementation” are not intended to be interpreted as excluding the existence of additional implementations that also incorporate the recited features. Moreover, unless explicitly stated to the contrary, implementations “comprising,” “including,” or “having” an element or a plurality of elements having a particular property may include additional elements whether or not they have that property. Moreover, the terms “comprising,” including, “having,” or the like are interchangeably used herein.

The terms “substantially,” “approximately,” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

There may be many other ways to implement the subject technology. Various functions and elements described herein may be partitioned differently from those shown without departing from the scope of the subject technology. Various modifications to these implementations may be readily apparent to those skilled in the art, and generic principles defined herein may be applied to other implementations. Thus, many changes and modifications may be made to the subject technology, by one having ordinary skill in the art, without departing from the scope of the subject technology. For instance, different numbers of a given module or unit may be employed, a different type or types of a given module or unit may be employed, a given module or unit may be added, or a given module or unit may be omitted.

Underlined and/or italicized headings and subheadings are used for convenience only, do not limit the subject technology, and are not referred to in connection with the interpretation of the description of the subject technology. All structural and functional equivalents to the elements of the various implementations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

1. An apparatus, comprising:
a system including a reagent cartridge receptacle;
a flow cell assembly;
a reagent cartridge receivable within the reagent cartridge receptacle, the reagent cartridge comprising a plurality of reagent reservoirs; and
a manifold assembly, the manifold assembly comprising a reagent selector valve adapted to be fluidically coupled to the reagent reservoirs and to selectively flow reagent from a corresponding reagent reservoir to the flow cell assembly, wherein at least a surface of the manifold assembly associated with the reagent selector valve is coupled to a portion of the flow cell assembly.

2. The apparatus of claim 1, wherein the surface of the reagent selector valve is directly mechanically coupled to the flow cell assembly.

3. The apparatus of claim 1, wherein the reagent selector valve comprises at least one of a ceramic rotor or a ceramic stator.

4. The apparatus of claim 1, wherein the manifold assembly further comprises a valve drive assembly operably coupled to the reagent selector valve.

5. The apparatus of claim 4, wherein the valve drive assembly comprises a brushless motor.

6. The apparatus of claim 1, wherein the manifold assembly comprises a flow cell valve coupled between the reagent selector valve and the flow cell assembly, wherein the flow cell assembly comprises a flow cell having a plurality of channels, wherein the flow cell valve is adapted to selectively flow reagent to the corresponding channels.

7. The apparatus of claim 6, wherein the flow cell valve comprises a plurality of outlet ports adapted to be coupled to corresponding channels of the flow cell.

8. The apparatus of claim 6, wherein the flow cell valve and the reagent selector valve have opposing surfaces, further comprising a valve drive assembly adapted to interface with the flow cell valve and the reagent selector valve at the opposing surfaces to control a position of the corresponding valves.

9. The apparatus of claim 6, wherein the flow cell valve comprises a flow cell valve body having a flow cell valve stator and a flow cell valve rotor, the flow cell valve body having a common fluidic line and a plurality of flow cell valve fluidic lines, the common fluidic line coupled to the reagent selector valve, and wherein the flow cell valve rotor interfaces with the flow cell valve stator to fluidically couple the common fluidic line and one or more of the flow cell valve fluidic lines.

10. The apparatus of claim 9, wherein the flow cell valve rotor comprises a radial groove adapted to fluidically couple the common fluidic line and the one or more of the flow cell valve fluidic lines.

11. The apparatus of claim 10, wherein the flow cell valve rotor comprises an arc-shaped groove coupled to a distal end of the radial groove and adapted to allow the common fluidic line to be fluidically coupled to more than one of the flow cell valve fluidic lines.

12. The apparatus of claim 1, wherein the reagent valve body comprises a flow cell interface and the flow cell assembly is coupled to the flow cell interface.

13. The apparatus of claim 1, further comprising a valve drive assembly adapted to interface with and be coupled adjacent to an end of the reagent selector valve.

14. The apparatus of claim 13, further comprising a vibration isolation assembly.

15. The apparatus of claim 14, wherein the vibration isolation assembly comprises a housing rotationally coupled to the reagent selector valve and the valve drive assembly.

16. An apparatus, comprising:
a flow cell assembly; and
a system including a manifold assembly and a flow cell receptacle adapted to carry the flow cell assembly, the manifold assembly comprising:
a reagent selector valve disposed immediately adjacent to the flow cell assembly, the reagent selector valve comprising a surface configured to directly couple to a portion of the flow cell assembly and adapted to selectively flow reagent to the flow cell assembly, wherein the reagent selector valve comprises at least one of a ceramic rotor or a ceramic stator; and
a valve drive assembly operably coupled to the reagent selector valve, the valve drive assembly comprising a brushless motor.

17. The apparatus of claim 16, wherein the reagent selector valve of the manifold assembly is disposed within the flow cell receptacle.

18. The apparatus of claim 16, wherein the surface of the reagent selector valve is adapted to be directly mechanically coupled to the flow cell assembly.

19. The apparatus of claim 16, wherein the manifold assembly further comprises a flow cell valve coupled between the reagent selector valve and the flow cell assembly, wherein the flow cell assembly comprises a flow cell having a plurality of channels, wherein the flow cell valve is adapted to selectively flow reagent to the corresponding channels.

20. The apparatus of claim 16, further comprising a vibration isolation assembly.

21. The apparatus of claim 20, wherein the vibration isolation assembly comprises a magnet and is adapted to magnetically levitate the manifold assembly.

22. The apparatus of claim 20, wherein the vibration assembly comprises a shock absorber.
